(19) United States
(12) Patent Application Publication
(10) Pub. No.: US 2024/0210356 A1
(43) Pub. Date: Jun. 27, 2024

(54) In-Situ Health Monitoring System for Redox Flow Batteries

(71) Applicant: BATTELLE MEMORIAL INSTITUTE, Richland, WA (US)

(72) Inventors: Xiaoqin Zang, Richland, WA (US); Zhiqun Deng, Richland, WA (US); Wei Wang, West Richland, WA (US); Litao Yan, Richland, WA (US); Zimin Nie, Edmonds, WA (US)

(21) Appl. No.: 18/541,396

(22) Filed: Dec. 15, 2023

Related U.S. Application Data
(60) Provisional application No. 63/426,487, filed on Nov. 18, 2022.

(51) Int. Cl. G01N 29/032; G01N 29/024; G01N 29/24; H01M 8/04313; H01M 8/18

(52) U.S. Cl. CPC G01N 29/032; G01N 29/024; G01N 29/2475; H01M 8/04313; H01M 8/188; G01N 2291/02416

(57) ABSTRACT

This document describes techniques and systems for in operando, non-invasive monitoring of byproducts that commonly arise within redox flow batteries. The described techniques and systems allow for accurate, inexpensive, portable, and real-time methods to measure evolution of gas bubbles and precipitates within the electrolyte solutions of redox flow batteries. System operators can monitor and maintain the amount of byproducts within the electrolyte solution by measuring an acoustic attenuation coefficient of the electrolyte solution and changes in the speed at which ultrasonic echoes propagate through the solution. The acoustic attenuation coefficient is measured using an ultrasonic transducer attached to a probing cell, which is connected to an electrolyte flow of a redox flow battery. The acoustic attenuation coefficient provides an accurate, real-time identification of byproducts that is generally insensitive to varying operational temperatures of the electrolyte solution. The probing cell also allows examination of the sound speed as it detects echoes of the transmitted frequencies.

### CROSS REFERENCE TO RELATED APPLICATION

This application claims the benefit of U.S. Provisional Patent Application No. 63/426,487, filed on Nov. 18, 2022, the disclosure of which is incorporated herein by reference in its entirety.

### STATEMENT OF GOVERNMENT INTEREST

This invention was made with Government support under Contract DE-AC0576RL01830 awarded by the U.S. Department of Energy and under Contract No. 70247 awarded by the U.S. Department of Energy Office of Electricity Energy Storage Program. The Government has certain rights in the invention.

### FIELD OF THE INVENTION

The present invention relates generally to monitoring electrolyte solutions of redox flow batteries for the presence of byproducts. More particularly, the present invention relates to systems and methods for measuring and analyzing acoustic characteristics of electrolyte solutions for detection of gaseous and solid byproducts generated within the electrolyte solution.

### BACKGROUND

Redox flow batteries are promising electrochemical energy storage devices for stational energy storage because of their extremely long cycle life (above 10000 cycles in deep discharge with low capacity decay) and high safety. However, parasitic side reactions during the operation of the battery can cause hydrogen gas to accumulate within the closed system of the redox flow battery. The accumulated hydrogen reduces the overall effectiveness and lifespan of the battery, and also presents a significant safety hazard due to risk of fire or explosion.

All-vanadium redox flow batteries (AVFB) represent a promising example of an electrochemical energy storage device for stational energy storage because of their extremely long cycle life (above 10000 cycles in deep discharge with low capacity decay) and high safety. Recently, it was reported that the potential of negative electrode was about 350 mv lower than that of a hydrogen reference electrode at 50% state of charge (SoC). The lower potential at negative electrode thermodynamically allows for simultaneous hydrogen evolution reaction (HER) to occur within the anolyte half-cell of the RFB. Since vanadium electrolyte generally uses concentrated (3-5 M) sulfuric acid, the potential for HER shifts more positively due to the high proton concentration, at the same time the potential of the V²⁺/V³⁺ redox reaction become more negative as increasing SoC, thereby increasing the driving force for HER. HER therefore represents a parasitic side reaction that occurs during operation of AVFBs. HER increases the hydrogen concentration in the negative reservoir, leading to a potential safety hazard. Recent study also showed that the hydrogen concentration could be higher than 8% (higher than hydrogen explosion limit of ˜4%) in the commercial AVFBs system after several months operation.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Ultrasonic probing systems and methods to detect the evolution of byproducts in redox flow battery are disclosed herein.

In certain aspects, methods for monitoring an amount of a byproduct in a redox flow battery having an electrolyte half-cell containing an electrolyte solution are disclosed herein. Methods can comprise (i) flowing the electrolyte solution from the electrolyte half-cell into a probing cell, (ii) transmitting a plurality of pulses into the probing cell with an ultrasonic transducer attached to a probing cell, (iii) receiving, by the ultrasonic transducer, a plurality of echoes from the plurality of pulses reflected by the probing cell, (iv) processing, by one or more processors of a computer system, the plurality of echoes to calculate a variability of the acoustic characteristic, the acoustic characteristic selected from an acoustic attenuation coefficient of the electrolyte solution and an average sound speed through the electrolyte solution, (v) determining an amount of a byproduct in the electrolyte solution based on the variability of the acoustic characteristic, and (vi) providing an indication when the amount of the byproduct exceeds a threshold amount.

In certain aspects, systems for monitoring an amount of a byproduct generated by a redox flow battery are disclosed. Systems can comprise a redox flow battery comprising a catholyte half-cell and an anolyte half-cell, and a battery health monitoring system. The battery health monitoring system can comprise (i) a probing cell connected to an outlet of a redox flow battery half-cell to receive an electrolyte solution from the redox flow battery, (ii) an ultrasonic system, (iii) and one or more processors of a computer system. The ultrasonic system can be configured to transmit pulses at a frequency into the probing cell and receive echoes from the transmit pulses (the echoes being reflections of the pulses). The one or more processors can be configured to detect changes in the acoustic characteristics of the electrolyte solution based on the echoes, process the echoes to calculate an acoustic characteristic selected from an acoustic attenuation coefficient of the electrolyte solution and an average sound speed through the electrolyte solution, determine, based on a variability of the acoustic characteristic, an amount of the byproduct in the electrolyte solution, and provide an indication when the amount of the byproduct in the electrolyte solution exceeds a predetermined threshold.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 shows a schematic drawing of an embodiment of a redox flow battery health monitoring system configured to detect gas bubbles in the anolyte solution.

FIG. 2 shows a schematic drawing of a second embodiment of a redox flow battery health monitoring system configured to detect precipitates within the catholyte solution.

FIG. 3 is a reproduction of the probing cell depicted in U.S. Pat. No. 11,415,552.

FIG. 4 represents experimental data from Example 1 showing variability of acoustic attenuation coefficient and sound speed of ultrasonic pulses within the electrolyte solution.

FIG. 5 represents experimental data from Example 1 showing variability of acoustic attenuation coefficient and sound speed of ultrasonic pulses within deionized water.

FIG. 6 depicts results from experiments performed in Example 2.

FIG. 7 depicts results from experiments performed in Example 3.

FIG. 8 depicts results from experiments performed in Example 3.

FIG. 9 depicts results from experiments performed in Example 3.

FIG. 10 is a flow diagram representing an example of a method to monitor byproducts within electrolyte solutions of a redox flow battery in accordance with one or more aspects of the described systems and techniques.

### DETAILED DESCRIPTION

One major parasitic side reaction that may occur during the operation of redox flow batteries is the hydrogen evolution reaction at the negative electrode. Several factors can affect hydrogen generation in a practical redox flow battery applications. For instance, in vanadium redox flow batteries, the vanadium electrolyte typically uses concentrated (3-5 M) acid that shifts the potential for hydrogen evolution positively. Flow batteries have incorporated carbon-based electrodes to capitalize on the high overpotential on the carbon surface to kinetically slow down this parasitic hydrogen generation, however, hydrogen generation remains a thermodynamic reality in redox flow battery operation.

A further concern for long-term cycling is the potential of the redox chemistry (e.g., the V²⁺/V³⁺ electrolyte pair) to become more negative as the state of charge (SoC) increases, thereby exacerbating the driving force for the hydrogen evolution reaction. Hydrogen generated within the half-cell not only blocks electrolyte access to the surface of the carbon electrode but also introduces mass and valence imbalances at the two electrodes, ultimately resulting in capacity decay and low energy efficiency. Further still, the accumulation of hydrogen gas generated in the negative half-cell reservoir presents a potential safety hazard.

Very little research has been done to investigate HER behaviors during real battery operations, with most of the research focusing on mitigating hydrogen generation and accumulation. A study documenting quantitative ex situ measurement to determine the hydrogen evolution reaction rate occurring at two different negative carbon paper electrodes was published, and the results demonstrated that the surface chemistry (e.g., functional groups), porosity, and surface area of the carbon electrode were the main factors that determines the hydrogen formation rate. An in situ investigation also reported observations of HER behaviors. A transparent battery was designed to visualize and record hydrogen gas bubbles during battery operation. While the results of that research provide understanding of the hydrogen generation rate and effects of electrode materials on the HER,

Non-invasive systems and methods able to predict and detect the generation of gas and solid byproducts formed within a redox flow battery, during its operation, would offer improvements to long-term capacity and safety of redox flow batteries, and it is to this purpose that the present disclosure is directed.

Reference will now be made in detail to exemplary aspects of the present disclosure that are illustrated in the accompanying drawings. Wherever possible, the same reference numbers will be used throughout the drawings to refer to the same or like parts.

The present disclosure relates to systems and methods used to monitor the presence of byproducts generated within flowing liquid solutions, particularly in the context of electrolyte solutions of redox flow batteries. Once detected, systems and methods disclosed herein can provide an indicator that byproducts are present within the electrolyte solutions, and this information can then be used to make operational changes to maintain high efficiency and reduce risk of damage to the system and injury.

Redox flow batteries disclosed herein are designed to incorporate health monitoring systems to detect and indicate the presence of byproducts formed within the redox flow battery cells. In certain aspects, systems contemplated herein can comprise a redox flow battery itself, and each of components typically found in redox flow batteries, including but not limited to those disclosed throughout U.S. Pat. Nos. 11,415,552, 9,236,620, 9,123,931 and 9,960,443, each of which is hereby incorporated by reference herein.

Generally, redox flow batteries as disclosed herein can comprise a catholyte half-cell and an anolyte half-cell separated from each other by an ion-permeable separator. Each of the catholyte half-cell and an anolyte half-cell can be in contact with an electrode that facilitates reduction or oxidation, respectively.

Systems disclosed herein may be operated under any suitable redox chemistry, and include any number of electrolyte solutions containing appropriate catholyte and anolyte pairs such as those disclosed in U.S. Pat. No. 11,415,552. In certain aspects, systems can comprise a flow battery employing all-vanadium polysulfide-bromide, uranium, zinc-bromine, zinc-cerium, soluble lead-acid, iron-salt, or vanadium-metal hydride chemistries. Redox flow batteries comprising other known catholyte and anolyte pairs are also contemplated herein, as would be understood by those of skill in the art.

Flow batteries based on redox-active organic molecules also are contemplated herein. Examples of redox-active organic monomer building blocks at the anode can include a phenazine, an anthraquinone, an alkoxazine, a viologen, a metal complex, a diazobenzene, a fluorenone, a naphthalene diimide, and combinations thereof. Examples of redox-active organic monomer building blocks at the cathode can comprise N-alkylated phenazines, 2,2,6,6-tetramethyl-1-piperidinyloxydanyl and its derivatives, a metallocene (e.g., a Zn-based metallocene, a Fe-based metallocene, a Cr-based metallocene, a Mn-based metallocene, a Co-based metallocene), a quinone, a phenothiazine, an N-alkylated phenoxazine, an N-alkylated phenothiazine, a metal complex, a catechol, a resorcinol, and combinations thereof. These building blocks can be assembled to dimer and oligomer forms within the battery, which can be formed as a σ-type linkage, or x-type linkage, across different combinations of the monomer building blocks.

Systems disclosed herein can further comprise a battery health monitoring system placed in line with the redox flow battery. Generally, the battery health monitoring system can allow the in-situ evaluation of a fluid flowing through the redox flow battery during its real-time operation, without interruption. In this manner, the battery health monitoring system may be able to continually sample the electrolyte solution within the redox flow battery for determination of the presence of gas and solid byproducts within. Gas byproducts are exemplified as hydrogen gas herein, as a common source of gas introduced within redox flow batteries system is the generation of hydrogen gas at the anode, and within the anolyte half-cell. However, it is also contemplated that other gaseous byproducts may be detected by the same systems and methods disclosed herein, without alteration to serve any particular byproduct. Solid byproducts in this disclosure primarily focus on metal oxide species (e.g., oxovanadium V₂O₅) that may form and precipitate from the catholyte solution at the cathode within the catholyte half-cell. Systems and methods disclosed herein are also applicable to the detection of alternate solid precipitates that may form or be introduced within the electrolyte solution of the redox flow battery system.

In certain aspects, the battery health monitoring system can be as described previously within U.S. Pat. No. 11,415,552 to include a probing cell through which the electrolyte solution flows, and an ultrasonic system connected to the probing cell for sampling the electrolyte solution. The ultrasonic system can comprise an ultrasonic pulser-receiver and an ultrasonic transducer arranged to transmit pulses of ultrasonic frequencies into the probing cell, and receive echoes of the pulses. The ultrasonic system may further comprise one or more processors configured to detect changes in the acoustic characteristics of the electrolyte solution based on the echoes received, in comparison to the pulse timing and characteristics.

The battery health monitoring system may be positioned, relative to the redox flow battery, adjacent the point at which the generation of byproducts may suspected within the redox flow battery. Without being bound by theory, it is believed that positioning the battery health system closer to the source of the generated byproduct may provide more responsive real-time data as to the presence and generation of byproducts. Thus, in certain aspects, the battery health monitoring system may be positioned adjacent an outlet of the anolyte half-cell for monitoring the generation of hydrogen gas generated at the negative electrode therein. Alternatively, the battery health monitoring system may be placed adjacent an outlet of the catholyte half-cell for monitoring the generation of a solid precipitant generated at the positive electrode therein.

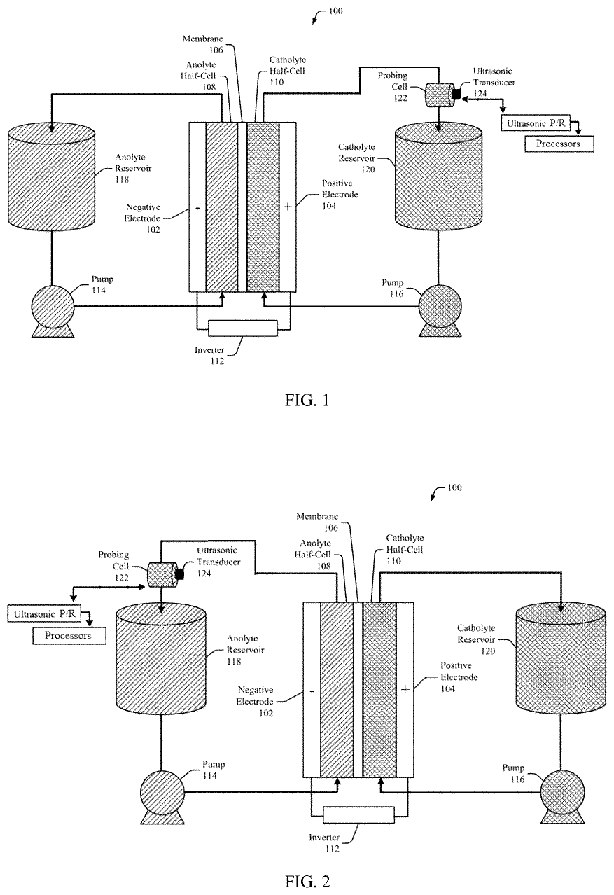

FIG. 1 provides an example of a system comprising a redox flow battery and a battery health monitoring system. The redox flow battery 100 includes a negative electrode 102, a positive electrode 104, a membrane 106, an anolyte half-cell 108, and a catholyte half-cell 110 in a sandwich-cell design. During a discharge cycle, reduction occurs at the catholyte half-cell 110 and oxidation occurs at the anolyte half-cell 108. The reduction and oxidation that occurs in a VRFB, as an example, is illustrated in Equations (1)-(3):

$$Negative : {V}^{3 +} + {e}^{-} ⇄ {V}^{2 +} , {E}^{0} = - 0.26 V \qquad ( Eq . 1 )$$

$$Positive : {VO}_{2}^{+} + 2 {H}^{+} + {e}^{-} ⇄ {VO}^{2 +} + {H}_{2} O , {E}^{0} = 1. V \qquad ( Eq . 2 )$$

$$Overall : {VO}_{2}^{+} + 2 {H}^{+} + {V}^{2 +} ⇄ {VO}^{2 +} + {H}_{2} O + {V}^{3 +} , E = 1.26 V \qquad ( Eq . 3 )$$

Similarly, during a charge cycle, reduction occurs at the anolyte half-cell 108, and oxidation occurs at the catholyte half-cell 110. While these redox reactions occur, proton ions diffuse across the membrane 106, and electrons transfer through an inverter 112. The inverter 112 changes direct current (DC) supplied by the redox flow battery 100 to alternating current (AC). The inverter 112 can be electronic, mechanical, or a combination thereof. The standard cell voltage of the redox flow battery 100 can be 1.26 V.

The redox flow battery 100 also includes pumps 114 and 116. The pump 114 circulates the anolyte electrolyte from an anolyte reservoir 118 to the anolyte half-cell 108 and past the membrane 106. Similarly, the pump 116 circulates the catholyte electrolyte from a catholyte reservoir 120 to the catholyte half-cell 110 and past the membrane 106.

Acoustic properties of the electrolyte solution in the redox flow battery 100 can be measured using a battery health monitoring system comprising probing cell 122 and ultrasonic transducer 124. The ultrasonic transducer 124 can be a piezoelectric transducer or another type of device that generates ultrasonic pulses, including a magnetostriction transducer. In the depicted example, the ultrasonic transducer 124 is mounted to a probing cell 122. The probing cell 122 is included in the flow path of the catholyte electrolyte. Alternatively, the ultrasonic transducer 124 can be mounted to a wall of the catholyte reservoir 120, such that the catholyte reservoir 120 may also function as the probing cell.

The battery health monitoring system may be configured to process the data collected at the ultrasonic pulser-receiver by further including one or more processors of a computer system. The processors generally may be configured to determine an amount of a byproduct in the electrolyte solution flowing through the probing cell and provide an indication when the determined amount of the byproduct in the electrolyte solution exceeds a predetermined threshold. To achieve this determination, processors can be further configured to detect an acoustic characteristic of the electrolyte solution flowing through the probing cell based on characteristics of the echoes, process the echoes to calculate either or both of a frequency-dependent acoustic attenuation coefficient of the electrolyte solution and an average sound speed through the electrolyte solution.

As exemplified below, it was surprisingly found that while the absolute changes in the measured acoustic characteristics were relatively static and therefore not ideal measures to correlate to and indicate the presence of gas or solid byproducts within the electrolyte solution. Surprisingly, the variability of the measured acoustic characteristic over a period of time did demonstrate a statistically significant correlation to the presence of gas and solid byproducts. Thus, in certain aspects, the processors of systems described herein can be configured to process a variability of either or both of the acoustic attenuation coefficient of the electrolyte solution and a variability of an average sound speed through the electrolyte solution.

In certain aspects, variability in the acoustic parameters can be expressed as the movement of an interquartile range (IQR) relative to a standard calculation. In the cases of both the acoustic attenuation coefficient and the average sound speed, an increase in the IQR values for these characteristics can be observed in the presence of non-liquid (e.g., solid or gas) byproducts within the electrolyte solution. For instance, the sound speed of a vanadium electrolyte solution without having gas bubbles introduced can be 1637.2 m/s, as demonstrated by FIG. 1 and Example 1. As hydrogen gas is introduced, the IQR of the sound speed increases marginally, but significantly, by about 0.1 to about 0.4 m/s. In other aspects, it is contemplated that determining the variability of the acoustic characteristic can comprise determining a change (e.g., increase or decrease) in the IQR of the sound speed by at least 0.1 m/s, at least 0.2 m/s, at least 0.3 m/s, at least 0.4 m/s, at least 0.5 m/s, or at least 1.0 m/s; alternatively, in a range from about 0.05 m/s to about 1.0 m/s, from about 0.1 m/s to about 0.5 m/s, or about 0.2 m/s to about 0.4 m/s.

Similarly, processing a variability of the acoustic characteristic can comprise calculating an amount and magnitude of outliers (e.g., changes in the standard deviation). In certain aspects, the standard deviation of the measured sound speed measurements to indicate the presence of a byproduct can be in a range from 0.1 to 2 m/s, from 0.1 to 1 m/s, or from 0.3 to 0.8 m/s. Alternatively, the standard deviation can be viewed as a threshold level for the indication of an undesirable operation condition. In certain aspects the threshold standard deviation for the sound speed can be 0.1 m/s, 0.2 m/s, 0.3 m/s, 0.4 m/s, 0.5 m/s, 0.6 m/s, 0.7 m/s, 0.8 m/s, or 1 m/s.

The standard deviation of attenuation coefficient measurements can be similarly applied to proportional ranges and thresholds. In certain aspects, the standard deviation of attenuation coefficient measurements can be in a range from 0.1 to 20 Np/m, 1 to 10 Np/m, or 3 to 8 Np/m. Alternatively, a threshold value for the standard deviation of attenuation coefficient may be applied at 0.5 Np/m, 1 Np/m, 2 Np/m, 3 Np/m, 4 Np/m, 5 Np/m, 6 Np/m, 7 Np/m, 8 Np/m, 9 Np/m, or 10 Np/m to indicate the presence of the byproduct.

Even more surprising, it was found that the amount of variability observed may be reliably correlated to the amount of the byproduct present within the electrolyte solution. However, as disclosed in U.S. Pat. No. 11,415,552 the values of acoustic characteristics also may be applied to the determination of the SoC of the redox flow battery through correlation of values. As shown in FIGS. 8a and 8b, the acoustic characteristics demonstrate a consistent variability depending on the state of charge (SoC) of the redox flow battery. When discharging the acoustic characteristics decrease, whereas the same characteristics increase during the charging cycle. Surprisingly, the variability of the acoustic characteristics was able to be deconvoluted from this cyclic variability, as shown in FIGS. 8c through 8f. Accordingly, the processors described herein can further be configured to deconvolute the cyclic variability arising from changes in the SoC occurring during operation, from the variability arising from the presence of gas and solid byproducts in the electrolyte solutions.

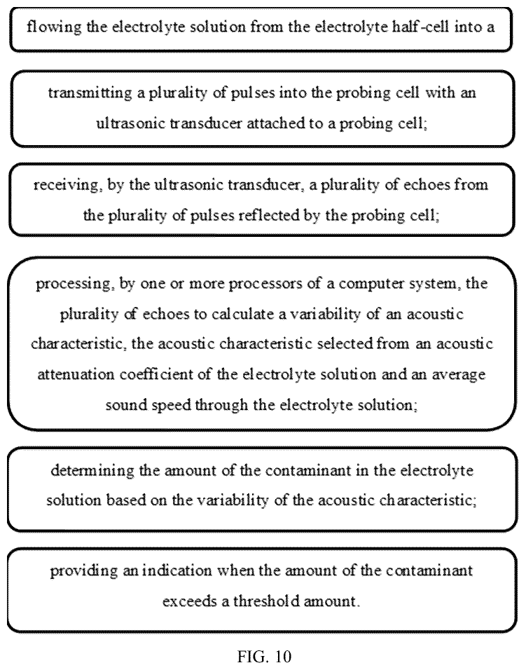

FIG. 10 depicts a flow chart detailing several method steps as described above, in relation to monitoring an amount of a byproduct in a redox flow battery during the operation of systems disclosed herein. In certain aspects, the method can comprise (i) flowing the electrolyte solution into a probing cell, (ii) transmitting a plurality of pulses into the probing cell with an ultrasonic transducer attached to a probing cell, (iii) receiving, by the ultrasonic transducer, a plurality of echoes from the plurality of pulses reflected by the probing cell, (iv) processing, by one or more processors of a computer system, the plurality of echoes to calculate a variability of the acoustic characteristic, the acoustic characteristic selected from an acoustic attenuation coefficient of the electrolyte solution and an average sound speed through the electrolyte solution; (v) determining an amount of a byproduct in the electrolyte solution based on the variability of the acoustic characteristic, and (vi) providing an indication when the amount of the byproduct exceeds a threshold amount.

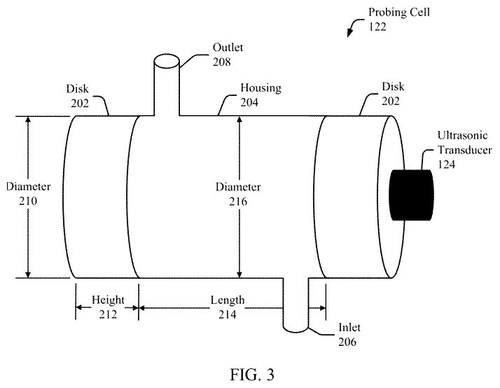

Flowing the electrolyte solution into a probing cell can be achieved in any suitable manner that allows the probing cell to continuously sample the electrolyte solution during operation of the redox flow battery. In certain aspects, as shown in FIG. 3, flowing the electrolyte solution into a probing cell can comprise flowing the electrolyte solution into inlet 206. Inlet 206 may be connected inline with a pipe delivering the electrolyte solution from the anolyte half-cell to an anolyte reservoir, as depicted in FIG. 1. The flow rate also is not limited to any particular amount, and generally can be in the range from 1 mL/min to 10 L/min. The flow rate may be static or variable.

Transmitting a plurality of pulses into the probing cell also may be conducted in any manner appropriate to achieve the intended output from the echoes received. In certain aspects, a frequency of a transmitted pulse can be in a range from 20 kHz to 10 MHz, or in other aspects from 20 kHz to 100 kHz. Pulses may be repeated within any amount of time to effect a continuous monitoring of the redox flow battery in real time. Receiving a plurality of echoes can similarly be recorded in intervals matching the pulse transmission frequency and the duration. The received plurality of echoes then may be coordinated to the phase, amplitude and frequency of the transmitted pulses during the processing step, as demonstrated throughout the examples disclosed below.

In certain aspects, the variability of the acoustic characteristic can be related to additional characteristics of the redox flow battery. For instance, as disclosed in U.S. Pat. No. 11,415,552, the acoustic attenuation coefficient and the average sound speed can vary through the charging/discharging cycles according to the state of charge. Thus, in certain aspects, determining an amount of a byproduct in the electrolyte solution based on the variability of the acoustic characteristic can further comprise deconvoluting an amount of variability of the acoustic characteristic caused by the presence of a gaseous or solid byproduct in the electrolyte solution from an amount of variability associated with the given change in state of charge during operation of the battery. In this manner, the variability attributed to the presence of the byproduct can be continuously and reliably determined.

Further aspects may provide an indication when the amount of the byproduct exceeds a threshold amount. This may be accomplished by any method suitable for a particular application. In certain aspects the indication may be an alert on a mobile phone to a user or set of users. In other aspects, this may be a physical alarm in the immediate vicinity of the redox flow battery. Similarly, the threshold amount can be any that are appropriate to protect the health and productivity of the redox flow battery. The following examples provide additional context for suitable threshold amounts, without limitation.

### EXAMPLES

The present disclosure is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

### Example 1. Acoustic Attenuation and Sound Speed Each Vary Significantly by the Introduction of Hydrogen Gas Bubbles into Electrolyte Solution

An offline experiment was performed to evaluate the existence of a correlation between acoustic characteristics and the presence of gas bubbles within an electrolyte solution. A probing cell was loaded with an electrolyte solution, and hydrogen gas was injected into the probing cell through a very thin tube connected with the inlet of the probing cell at five different flow rates (2, 4, 6, 8, and 10 cc/min). A control experiment was also performed where no gas was injected. The inlet was sealed tightly to avoid any liquid leakage. The hydrogen gas injection formed bubbles within the probing cell having a diameter of bubbles in a range of about 2-3 mm. Acoustic measurements were taken every 10 seconds for 400-500 repetitions, from which sound speed and acoustic attenuation constants were calculated. The above experiment and analysis was also performed by injecting nitrogen into DI water at varying gas flow rates. Acoustic measurements were performed every 10 seconds for 200-400 times.

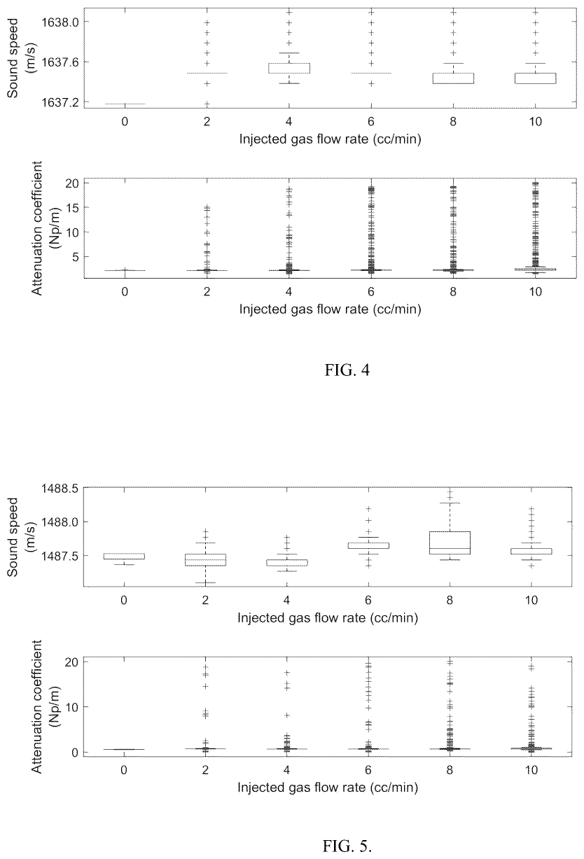

Sound speeds and attenuation coefficients are presented in boxplots for deionized water (FIG. 5) and anolyte solutions (FIG. 4). In each box, the central mark indicates the median, and the bottom and top edges of the box indicate the 25^{th} percentile (Q1) and 75^{th} percentile (Q3), respectively. The difference between Q3 and Q1 are the interquartile ranges. Whiskers that extend to the most extreme data points (maximum: Q3+1.5*IQR, minimum: Q1 −1.5*IQR) are not considered outliers. Outliers that were observed are plotted using ‘+’ symbols.

In the boxplots of FIGS. 4-5, bubbles can be represented as outliers (denoted by ‘+’ symbols) and/or increased interquartile ranges (the difference between two whiskers denoted by black bars), both of which demonstrate increased variability in acoustic measurements of the anolyte solution. When no bubbles exist in the fluid, there are no outliers in both sound speed and attenuation coefficient, and the interquartile range is very small. Depending on how sound speed measurements are distributed, cases where median values overlap with the box edge occur when the median value is equal to the first/third quartile values.

When hydrogen gas was injected into the test fluid, we observed many outliers in both sound speed and attenuation coefficient measurements, and the IQR is larger than that observed for no gas cases. As understood by those of the art, outliers are defined as a value that is outside the IQR by at least 1.5 times the range of the IQR. Moreover, the IQR and number of outliers generally increase as the gas flow rate increases, indicating that more bubbles are detected by acoustic measurements at higher gas flow rates. We also found that the attenuation coefficient measurement seems more sensitive to gas bubbles, as indicated by the presence of many more outliers than found in sound speed measurements at the same gas flow rate. Overall, when hydrogen gas was injected into the electrolyte solutions, the variabilities of both sound speed and attenuation coefficient were much higher than when no gas was injected.

To quantify the relationship between variations of electrolyte acoustic properties and injected gas flow rates, the std and IQR were correlated with the gas flow rates. The correlation coefficients with corresponding p-values are listed in Table 1.

TABLE 1
Correlation coefficients of acoustic properties
and the injecting gas flow rates.

| | | Correlation | Correlation |
|---|---|---|---|
| | | Coefficient | Coefficient |
| Testing | Acoustic | between std and | between IQR and |
| Liquid | Properties | Gas Flow Rate | Gas Flow Rate |
| Deionized | Sound speed | 0.67 (p = 0.15) | 0.77 (p = 0.08) |
| water | Attenuation | 0.92 (p = 0.01) | 0.79 (p = 0.06) |
| | coefficient | | |
| Vanadium | Sound speed | 0.89 (p = 0.02) | 0.68 (p = 0.13) |
| negative | Attenuation | 0.95 (p = 0.00) | 0.80 (p = 0.06) |
| electrolyte | coefficient | | |
| solution | | | |

For the test in deionized water, the linear correlation is statistically significant (p<0.05) for attenuation coefficient, with 0.92 correlation coefficient between the std and gas flow rate. For the test in the anolyte solution, the linear correlation is statistically significant (p<0.05) both the std of the sound speed and the std of the attenuation coefficient.

In summary, surprisingly, for both deionized water and vanadium electrolyte solutions, each of the standard deviation of the attenuation coefficient are linearly correlated with the flow rate of injected gas. Linear correlations between the variability (both std and IQR) of acoustic measurements and the gas flow rate provide strong indicators of the amount of gas bubbles in the electrolyte solution.

### Example 2. Detection of Intermittent Production of Gas Bubbles in a Quasi-In-Situ Experiment

A quasi-in-situ experiment was performed in application of the correlation identified in Example 1 to the detection of hydrogen bubbles in a flow battery system and ultimately to the management of operational battery health. In this experiment, hydrogen gas was intentionally generated using a Pt/C electrode acting as a catalyst to facilitate hydrogen generation at the negative electrode. A V³⁺ solution was used as anolyte, and V⁴⁺ solution was used as catholyte. The flow system was driven by a pump at speed of 20 mL/min. The charge voltage was 1.3 V, and the current was 0.032 A. Hydrogen bubbles were observed flowing in the anolyte solution.

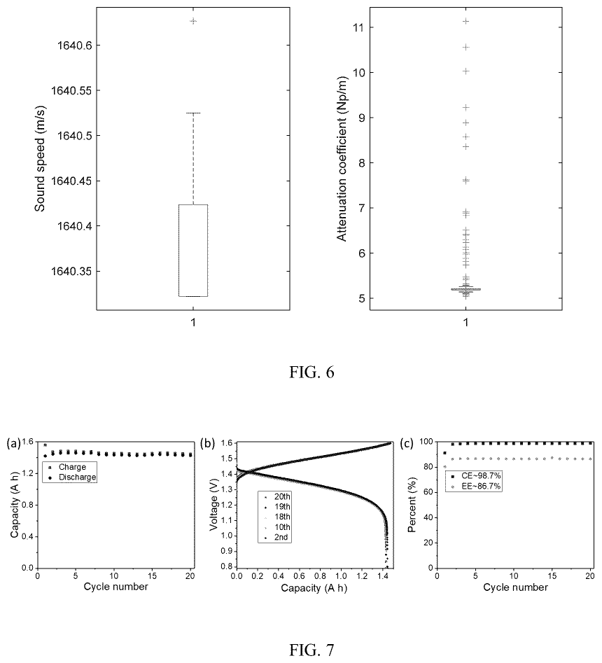

As opposed to the steady stream of consistently-sized bubbles observed in Example 1, this experimental arrangement resulted in intermittent bubble trains and clouds observed flowing through the acoustic cell, at intervals varying from about 15 seconds to about 45 seconds. Sometimes a few scattered bubbles appeared in a train; more often bubbles aggregated as clouds. Bubble diameter varied, mostly <1 mm by visual estimation. The system was run continuously for 30 minutes. Sound speed and attenuation coefficients were plotted in box plots were calculated as for Example 1 above and shown in FIG. 6.

Unlike the experiment above where gas bubbles were introduced through a tube in regular intervals, no significant variability was found in the sound speed measurements. Without being bound by theory, the relatively small size of bubbles in this experiment relative to Example 1 (<1 mm vs. 2-3 mm) may be a contributing cause to the relatively static sound speed measurements, or in other words, to the inability to detect statistically significant variability in the sound speed in the presence of the generated bubbles. Surprisingly, even despite the small bubble size, variability in the calculated acoustic attenuation coefficients was sufficient to detect the presence of bubbles within the solution according to the variability, expressed as either the amount and magnitude of outliers (standard deviation) or by changes in the interquartile range.

### Example 3. In Situ Online Experiment

An in-situ experiment with validation was performed to apply, in the context of a redox flow battery, the correlation between the presence of byproducts in and the variability of acoustic characteristics of the electrolyte solution. A cycling test at a cut-off potential window between (0.8 V and 1.6 V) was performed prior to the hydrogen bubble test to guarantee normal operation of the flow cell. For the charging process at the 21^{st} cycle, the voltage applied on the cell was increased to 1.8 V, 1.9 V, and 2.0 V. The cell voltages were held at each of those voltages for around 15 minutes. As the applied voltage increases on the flow cell, the current density increased and the potential at the negative electrode became more negative. This led to the generation of more hydrogen gas bubbles. A hydrogen detector (HY-ALERTA™ 500, H2scan, California, USA) was connected to the headspace of the V²⁺/V³⁺ electrolyte reservoir with stainless tubing as a control measurement of the hydrogen gas generated within the negative electrolyte solution.

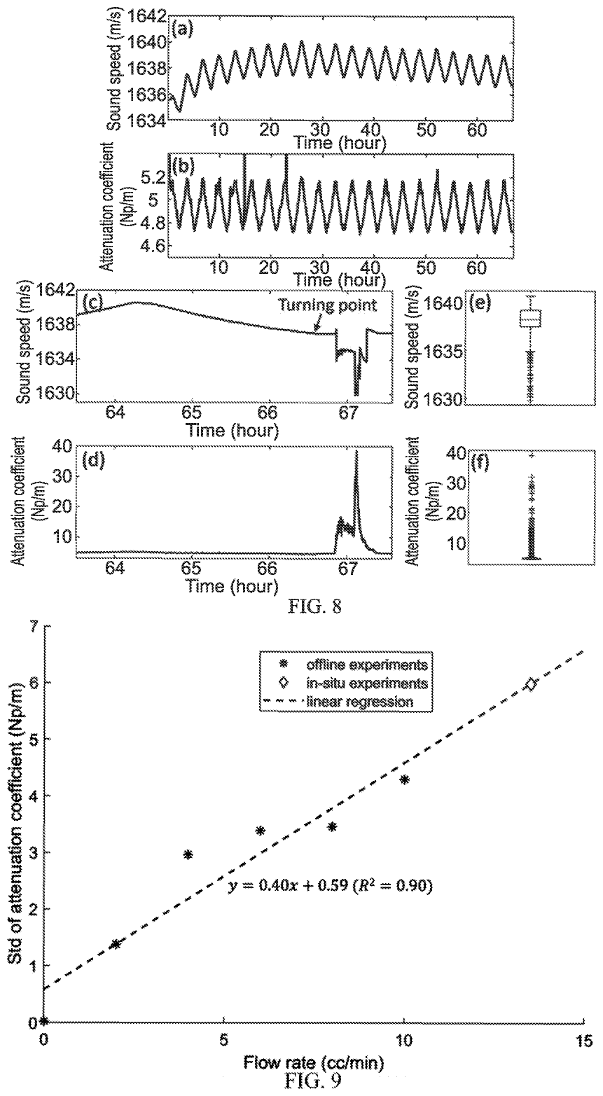

When the charge cutoff voltage was increased from 1.8V to 1.9 V at hour 66.85, large gas bubbles were observed visually and were detected by acoustic measurements (FIG. 7). The appearance of hydrogen gas bubbles was confirmed by the HY-ALERTA™ 500 hydrogen detector. A valve was installed in electrolyte flow path and flashing red rights on the sensor observed just after the valve was opened indicated the presence of hydrogen in the flowing electrolyte.

Before hydrogen bubble testing, cycling tests was performed for the cell in a 0.8 V-1.6 V potential window. Almost no charge/discharge capacity loss was observed, and the ˜1.45 Ah capacity could be maintained over the first 20 cycles (FIGS. 7.a and 7.b). FIG. 7.c shows the columbic efficiency (CE) and energy efficiency (EE) results obtained during cycling tests for the investigated battery. The CE and EE were maintained at ˜99% and ˜87% for the first 20 cycles, respectively. The stable battery performance during cycling indicates that the investigated battery operated normally.

FIG. 8 highlights the experiment when hydrogen bubbles were generated by extreme voltage levels. The sound speed (FIG. 8a) and attenuation coefficient (FIG. 8b) periodically varied during the first 20 charge/discharge cycles. FIG. 8a and FIG. 8b also show that sound speed and attenuation coefficient linearly decrease with the SoC, which linearly increases with increasing charge time at each cycle. The cycling curves shown in FIG. 8a and FIG. 8b clearly show that our ultrasonic probing system can monitor the SoC of the negative electrolyte.

In the 21^{st} cycle of the charging process at a constant current density of 75 mA/cm2, we found the change in the sound speed (FIG. 8c) and attenuation coefficient (FIG. 8d) to be linear over the first two hours (from hour 64.25 to hour 66.25), which indicates that the main contribution of the V²⁺/V³⁺ redox reaction is at negative side. Note that results shown in FIG. 8a and FIG. 8c are for the same test but at different voltage conditions. The two plots are displayed in different scales to show the difference between the clear cycling pattern under normal operations (FIG. 8a) and when large variability occurs under extreme conditions (FIG. 8c). The same thing is true for the attenuation coefficient results shown in FIG. 8b and FIG. 8d. After 2 hours charging, the charge capacity reached 1.5 Ah, and the capacity utilization was almost 90%. At hour 66.58, the sound speed curve reaches a turning point where the slope changes abruptly from −0.3 to 0 because the variation of sound speed plateaued for 15 minutes (i.e., the slope of sound speed curve was unchanged). Theoretically, only two reactions can occur at the negative side during the charge process—the V²⁺/V³⁺ redox reaction and hydrogen evolution. The 15-minute plateau is an indication that hydrogen generation had started, although the acoustic measurement was not able to detect the gas bubbles during that period. It is noted that the charge voltage was nearly 1.7 V after charging for 2 hours.

After the flow cell was charged to 1.8 V, the applied voltage of 1.8 V was retained for about 15 minutes (from hour 66.58 to hour 66.85). The sound speed and attenuation coefficient were maintained at constant levels, and no abrupt decreases/increases were observed (FIG. 8c and FIG. 8d). Therefore, during the time period when the cell was maintained at 1.8 V, V²⁺/V³⁺ redox reaction happened at negative side was limited because no changes in sound speed and attenuation coefficient were observed, which indicates that hydrogen evolution is the main reaction that occurs at the negative electrode at this voltage, although again, no hydrogen gas bubbles could be detected by our acoustic detector. Generally, the small amount of hydrogen bubbles initially adsorbed on the electrode then coalesced to form a bubble that was large enough to be released into the flowing electrolyte and detected by our acoustic detector. The absence of a large bubble flowing through the glass cylinder during the time when the cell was maintained at 1.8 V is possibly the reason no hydrogen was detected. Another possible reason is that a small amount of hydrogen in small bubbles could not be detected by our acoustic detector. We expect that in commercial flow battery systems, where the electrode size would be much larger than those at laboratory scale, hydrogen bubbles can aggregate more rapidly and can be detected earlier than in the laboratory experiments.

When we increased the charge cutoff voltage from 1.8V to 1.9 V at hour 66.85, large gas bubbles were observed visually and were detected by acoustic measurements (FIG. 8c and FIG. 8d). For sound speed, when higher voltage was enforced, sound speeds abruptly decreased for about 25 minutes. Simultaneously, the attenuation coefficient abruptly increased. The boxplot of sound speeds (FIG. 8e) shows many outliers with speeds that are lower than the minimum sound speed observed under normal conditions, while the boxplot of attenuation coefficients (FIG. 8f) shows many outliers that are larger than the maximums observed under normal conditions. The appearance of hydrogen gas bubbles was validated by the HY-ALERTA™ 500 hydrogen detector that was installed in a flow battery system. A valve was installed in electrolyte flow path and flashing red rights on the sensor observed just after the valve was opened indicated the presence of hydrogen in the flowing electrolyte.

### Example 4. Determination of the Hydrogen Flow Rate of the In-Situ Experiment Using Linear Correlation Between Standard Deviation and Gas Flow Rate

Based on the results of the offline static experiments (denoted by blue stars in FIG. 9), a linear relationship (the black dashed line in FIG. 9) between the flow rate and the std of the attenuation coefficient was established. Since the std is a statistical metrics that can measure the amount of variation of the whole dataset, it is more appropriate to be used to estimate the flow rate than the IQR, which only denotes the range of the middle 50% of the dataset. The linear relationship was then used to estimate the hydrogen flow rate of the in-situ experiment. The attenuation coefficient measurements between hour 66.85 to 67.27, during which time bubbles were visually observed in the glass measurement cell, were extracted and their std value was calculated as 5.99 Np/m. Inserting the std value to the linear relationship yielded a flow rate of 13.50 cc/min, i.e. the estimated average hydrogen gas flow rate during the in-situ experiment is 13.50 cc/min. It should be noted that the linear relationship only crudely estimated the hydrogen gas flow rate, since the bubbles generated in the in-situ experiments were in different size with the static offline experiments. During the offline experiments, gases were injected into the solution through a tube, and the gas bubbles have larger diameters (approximately 3 mm by visual estimation). While in the in-situ experiments, the bubbles were in smaller size (approximately 1 mm by visual estimation). Bubbles in offline experiments aligned like a bead-chain while in the in-situ experiments small bubbles aggregated in the form of clouds. Despite of the difference in bubble size and forms, the std of attenuation coefficient is still a good quantitative metrics to estimate the flow rate of hydrogen gas bubbles generated in the negative electrolyte, and the acoustic detection approach is a robust noninvasive method that can monitor the hydrogen bubble generation levels quantitatively.

From the results of Examples 1-4 disclosed herein, we have developed a method for predicting and monitoring hydrogen generation in VRBs during the charging process. Although the acoustic measurement cannot detect the hydrogen bubbles during the very early stage of hydrogen generation (i.e., when the applied voltage was <1.8 V), our acoustic measurement approach can provide early indications/predictions of hydrogen generation by identifying changes in the sound speed slope at the onset of the hydrogen generation. Moreover, when a higher voltage was applied, an abrupt decrease in sound speed and an abrupt increase in attenuation clearly indicate hydrogen gas bubbles generation. We found that the standard deviation of the attenuation coefficient has a linear relationship with hydrogen bubble amounts and flow rates. With more ultrasonic measurements of charge-discharge cycling at the negative half-cell, we will develop machine learning models to build a robust and comprehensive tool to predict and monitor the state of charge and state of health monitoring of VRBs.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Various advantages and novel features of the present disclosure are described herein and will become further readily apparent to those skilled in this art from the following detailed description. In the preceding and following descriptions the preferred embodiments of the disclosure have been shown and described by way of illustration of the best mode contemplated for carrying out the disclosure. As will be realized, the disclosure is capable of modification in various respects without departing from the disclosure. Accordingly, the drawings and description of the preferred embodiment set forth hereafter are to be regarded as illustrative in nature, and not as restrictive.

1. A system for monitoring an amount of a byproduct generated by a redox flow battery, the system comprising:
a redox flow battery comprising a catholyte half-cell and an anolyte half-cell; and
a battery health monitoring system comprising:
a probing cell connected to an outlet of a redox flow battery half-cell to receive an electrolyte solution from the redox flow battery;
an ultrasonic system, comprising:
an ultrasonic pulser-receiver; and
an ultrasonic transducer attached to the probing cell, the ultrasonic transducer configured to:
transmit pulses at a frequency into the probing cell; and
receive echoes, the echoes being reflections of the pulses; and
one or more processors of a computer system, the one or more processors configured to:
detect changes in the acoustic characteristics of the electrolyte solution based on the echoes.
process the echoes to calculate an acoustic characteristic selected from an acoustic attenuation coefficient of the electrolyte solution and an average sound speed through the electrolyte solution;
determine, based on a variability of the acoustic characteristic, an amount of the byproduct in the electrolyte solution; and
provide an indication when the amount of the byproduct in the electrolyte solution exceeds a predetermined threshold.

2. The system of claim 1, wherein the redox flow battery half-cell is an anolyte half-cell.

3. The system of claim 2, wherein the probing cell is connected to receive an anolyte solution from the anolyte half-cell.

4. The system of claim 2, wherein the byproduct is a gas.

5. The system of claim 2, wherein the byproduct is hydrogen gas.

6. The system of claim 1, wherein the redox flow battery half-cell is an anolyte half-cell.

7. The system of claim 6, wherein the probing cell is connected to receive a catholyte solution from the catholyte half-cell.

8. The system of claim 6, wherein the byproduct is a solid precipitate.

9. The system of claim 6, wherein the byproduct is an oxovanadium compound having a volume average particle size in a range from 0 to 100 nm.

10. The system of claim 1, wherein the probing cell is further connected to an electrolyte reservoir inlet to receive the electrolyte solution from the BHMS.

11. The system of claim 1, further comprising a pump to return the electrolyte from the electrolyte reservoir to the redox flow battery half-cell.

12. A method for monitoring an amount of a byproduct in a redox flow battery having an electrolyte half-cell containing an electrolyte solution, the method comprising:
flowing the electrolyte solution into a probing cell;
transmitting a plurality of pulses into the probing cell with an ultrasonic transducer attached to a probing cell;
receiving, by the ultrasonic transducer, a plurality of echoes from the plurality of pulses reflected by the probing cell;
processing, by one or more processors of a computer system, the plurality of echoes to calculate a variability of the acoustic characteristic, the acoustic characteristic selected from an acoustic attenuation coefficient of the electrolyte solution and an average sound speed through the electrolyte solution;
determining an amount of a byproduct in the electrolyte solution based on the variability of the acoustic characteristic;
providing an indication when the amount of the byproduct exceeds a threshold amount.

13. The method of claim 12, wherein the acoustic characteristic is the acoustic attenuation constant of the electrolyte solution.

14. The method of claim 12, wherein the acoustic characteristic is the average sound speed of through the electrolyte solution.

15. The method of claim 12, wherein the electrolyte solution is an anolyte solution.

16. The method of claim 15, wherein the anolyte solution is a V³⁺ solution prepared by charging VOSO₄ and H₂SO₄ aqueous solutions.

17. The method of claim 12, wherein the byproduct is hydrogen gas.

18. The method of claim 12, wherein the electrolyte solution is a catholyte solution.

19. The method of claim 17 wherein the catholyte solution is a V⁴⁺ solution.

20. The method of claim 12, wherein the byproduct is a solid precipitant.
